(19) United States
(12) Patent Application Publication
(10) Pub. No.: US 2008/0003514 A1
(43) Pub. Date: Jan. 3, 2008

(54) Method of preparing toner and toner prepared using the method

(75) Inventors: Yo-da Shin, Incheon Metropolitan-city (KR); Chang-kook Hong, Suwon-si (KR); Min-young Cheong, Seoul (KR); Kyung-yol Yon, Seongnam-si (KR); Sang-soon Lim, Seocheon-gun (KR); Su-bum Park, Daejeon Metropolitan-city (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/653,936

(22) Filed: Jan. 17, 2007

(30) Foreign Application Priority Data
Jun. 29, 2006 (KR) 10-2006-0059243

(51) Int. Cl. G03G 9/087

(52) U.S. Cl. 430/109.3; 430/137.14; 430/123.5

(57) ABSTRACT

A method of preparing toner is provided, including: forming polymer latex particles by polymerizing a toner composition including a macromonomer having a hydrophilic group, a hydrophobic group, and at least one reactive functional group, a polymerizable monomer, a chain transfer agent, and an initiator; aggregating the polymer latex particles; and separating and drying the polymerized toner. The polymerizable monomer is selected to produce at least two groups of polymer latex particles having different molecular weights, wherein the polymer latex particles are selected from the group consisting of a first latex polymer group having a molecular weight less than about 20,000, a second latex polymer group having a molecular weight of about 20,000 to 40,000, a third latex polymer group having a molecular weight of about 40,000 to 50,000, and a fourth latex polymer group having a molecular weight of about 50,000 to 100,000. Also provided are a toner prepared using the method, an image forming method using the toner, and an image forming apparatus employing the toner. Thus, the size and shape of the toner particles can be efficiently adjusted, and a toner having low temperature fixing properties, storability, cleaning properties, and durability can be obtained.

### CROSS-REFERENCE TO RELATED PATENT APPLICATION

This application claims the benefit under 35 U.S.C. § 119(a) of Korean Patent Application No. 10-2006-0059243, filed on Jun. 29, 2006, in the Korean Intellectual Property Office, the disclosure of which is hereby incorporated by reference in its entirety.

### BACKGROUND OF THE INVENTION

1. Field of the Invention

The present invention relates to a method of preparing toner and to a toner prepared using the method. More particularly, the invention relates to a method of preparing toner by adjusting the molecular weight of a polymerizable monomer to adjust the size and shape of the toner particles. The invention is further directed to a toner prepared using the method, a method of forming an image using the toner, and an image forming apparatus employing the toner.

2. Description of the Related Art

In an electrophotographic process or an electrostatic recording process, a developer used to shape an electrostatic image or an electrostatic latent image may be a two-component developer, formed of a toner and carrier particles, or a one-component developer, formed of a toner only. The one-component developer may be a magnetic one-component developer or a nonmagnetic one-component developer. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toners include pulverization methods or polymerization methods. In the pulverization method, the toner is obtained by melting and mixing synthetic resins with colorants and, if needed, other additives, pulverizing the mixture and sorting the particles until particles of a desired size are obtained. In the polymerization method, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to shape minute liquid droplet particles. Subsequently, the temperature is increased and suspension polymerization is performed to obtain a polymerized toner having coloring polymer particles of a desired size.

In an image forming apparatus such as an electrophotographic apparatus or an electrostatic recording apparatus, an electrostatic latent image is formed through light-exposing the surface of a photoreceptor which is uniformly charged. A toner is attached to the electrostatic latent image, and a resulting toner image is transferred to a transfer medium such as a paper through several processes such as heating, pressing, solvent steaming, and the like. In most fixing processes, the transfer medium with the toner image passes through fixing rollers and pressing rollers, and by heating and pressing, the toner image is fused to the transfer medium.

Images formed by an image forming apparatus such as an electrophotocopier should satisfy requirements of high precision and accuracy. Conventionally, a toner used in an image forming apparatus is usually obtained using a pulverization method. When using pulverization, color particles having a large range of sizes are formed. Hence, to obtain satisfactory developer properties, there is a need to sort the coloring particles obtained through pulverization according to size to reduce the particle size distribution. However, it is difficult to precisely control the particle size distribution using a conventional mixing/pulverizing process in the manufacture of toner particles suitable for an electrophotographic process or an electrostatic recording process. Also, when preparing a minute particle toner, the toner preparation yield is low due to a sorting process. In addition, there is a limit to a change/adjustment of a toner design for obtaining desirable charging and fixing properties. Accordingly, polymerized toners, in which the size of particles is easy to control and which do not need to undergo a complex manufacturing process such as sorting, have come into the spotlight recently.

When a toner is prepared using a polymerization method, a polymerized toner with a desired particle diameter and diameter distribution can be obtained without pulverizing or sorting.

U.S. Pat. No. 6,033,822 to Hasegawa et al. discloses a polymerized toner, wherein the polymerized toner includes core particles and shells covering the core particles and is prepared by suspension polymerization. However, it is still difficult to control the shape of the toner and the size of the particles using this method. Moreover, the distribution of the diameter of the particles is wide.

U.S. Pat. No. 6,258,911 to Georges et al. discloses “bifunctional macromolecules and toner compositions therefrom”, having a narrow polydispersity and a method of emulsification-aggregation polymerization which prepares polymer having free radicals that are covalently-bonded at both ends of the polymer. However, even when using such a method, a surfactant may induce inverse effects and it is difficult to control the size of the latex particles.

### SUMMARY OF THE INVENTION

The present invention provides a method of preparing toner, wherein the size and shape of particles of the toner can be efficiently adjusted and where the resulting toner has excellent storability and durability.

The present invention also provides a toner, wherein the size and shape of particles of the toner can be efficiently adjusted and where the toner has excellent storability and durability.

The present invention also provides a method of forming images using the toner, wherein the size and shape of particles of the toner can be efficiently adjusted and where the toner has excellent storability and durability.

The present invention also provides an image forming apparatus using the toner, wherein the size and shape of particles of the toner can be efficiently adjusted and where the toner has excellent storability and durability.

According to an aspect of the present invention, a method of preparing toner is provided where the method comprises: forming polymer latex particles by polymerizing a toner composition comprising a macromonomer having a hydrophilic group, a hydrophobic group, and at least one reactive functional group, a polymerizable monomer, a chain transfer agent, and an initiator; aggregating the polymer latex particles; and separating and drying the polymerized toner, wherein the polymerizable monomer is selected to produce at least two polymer latex particles having different molecular weights, wherein the polymer latex particles are selected from the group consisting of a first latex polymer group having a molecular weight (Mw) less than about 20,000, a second latex polymer group having a molecular weight of about 20,000 to 40,000, a third latex polymer group having a molecular weight of about 40,000 to 50,000, and a fourth latex polymer group having a molecular weight of about 50,000 to 100,000.

According to another aspect of the present invention, a toner is obtained that is prepared by forming polymer latex particles by polymerizing a toner composition by mixing a macromonomer having hydrophilicity and hydrophobicity, and at least one reactive functional group, a polymerizable monomer, a chain transfer agent, and an initiator with a colorant dispersion solution to shape polymer latex particles, and by aggregating the polymer latex particles and separating and drying the aggregated toner, wherein the polymerizable monomer is selected to produce at least two polymer latex particles having different molecular weights, wherein the polymer latex particles are selected from the group consisting of a first latex polymer group having a molecular weight (Mw) of about 20,000 or less, a second latex polymer group having a molecular weight (Mw) of about 20,000 to 40,000, a third latex polymer group having a molecular weight (Mw) of about 40,000 to 50,000, and a fourth latex polymer group having a molecular weight (Mw) of 50,000 to 100,000.

According to another aspect of the present invention, an image forming method is provided, comprising: forming a visible image by disposing toner to a surface of a photoreceptor on which an electrostatic latent image is formed; and transferring the visible image to a transfer medium, wherein the toner is a toner prepared according to the above described method.

According to another aspect of the present invention, an image forming apparatus is provided comprising: an organic photoreceptor; an image forming unit to form an electrostatic latent image on a surface of the organic photoreceptor; a toner cartridge to contain the toner prepared according to the above described method; a toner supplying unit to supply the toner to the surface of the organic photoreceptor to develop the electrostatic latent image on the surface of the organic photoreceptor into a toner image; and a toner transferring unit to transfer the toner image on the surface of the organic photoreceptor to a transfer medium.

According to the present invention, a toner, the size and shape of the particles of which can be efficiently adjusted and which have excellent storability and durability, can be prepared using a method of preparing a toner, which is environment-friendly and can be simplified, thereby reducing the manufacturing costs.

### BRIEF DESCRIPTION OF THE DRAWING

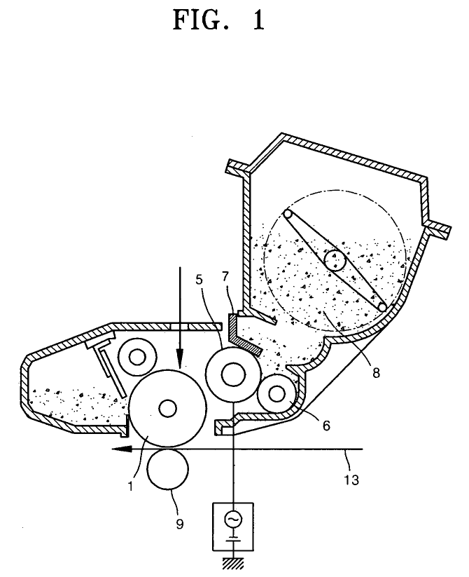

The above and other features and advantages of the present invention will become more apparent by describing in detail exemplary embodiments thereof with reference to FIG. 1 which illustrates an image forming apparatus according to an embodiment of the present invention.

### DETAILED DESCRIPTION OF THE INVENTION

A method of preparing toner according to an embodiment of the present invention includes: forming polymer latex particles by polymerizing a toner composition including a macromonomer having a hydrophilic group and a hydrophobic group and at least one reactive functional group, a polymerizable monomer, a chain transfer agent, and an initiator; aggregating the polymer latex particles; and separating and drying the polymerized toner, wherein the polymerizable monomer is selected to produce at least two groups of polymer latex particles having different molecular weights, wherein the polymer latex particles are selected from the group consisting of a first latex polymer group having a molecular weight (Mw) less than about 20,000, a second latex polymer group having a molecular weight (Mw) of about 20,000 to 40,000, a third latex polymer group having a molecular weight (Mw) of about 40,000 to 50,000, and a fourth latex polymer group having a molecular weight (Mw) of about 50,000 to 100,000.

The glass transition temperature of the first latex polymer group is about 30 to 40° C., the glass transition temperature of the second latex polymer group is about 40 to 50° C., the glass transition temperature of the third latex polymer group is about 50 to 60° C., and the glass transition temperature of the fourth latex polymer group is about 60 to 65° C.

The present invention relates to a method of preparing polymerized toner particles, in which the size and shape of the final toner particles can be adjusted by varying the combination weight ratio of at least two polymer latex particles having various molecular weights, which are synthesized during the polymerization process or by varying the aggregation time and the amount of an aggregating agent during the aggregation process. The molecular weight of the polymer latex and the glass transition temperature Tg can be adjusted by varying the amount and kind of the polymerizable monomer, the amount and molecular weight of the macromonomer, and/or the amount of the chain transfer agent.

The size and shape of the final toner particles can be controlled by using at least two polymerized latex polymer particles having different molecular weights and glass transition temperatures that are produced using different monomers and/or different amounts of various monomers. Specifically, in the case of a latex polymer having a very high molecular weight produced from polymerizable monomers, irregular particles are obtained, and in the case of relatively high molecular weight polymer latex particles produced from polymerizable monomers, potato-shaped toner particles are obtained. In addition, the lower the molecular weight polymer latex particles from the polymerizable monomers, the more spherical the shape of the toner particles. The potato-shaped toner particles can be changed to spherical toner particles by prolonging the aggregation time of the polymerized polymer latex. In contrast, potato-shaped toner particles can be obtained by reducing the aggregation time. Accordingly, the size and shape of the toner particles can be controlled by adjusting at least one condition selected from the molecular weight of the polymerized latex particles and/or the polymerizable monomer, glass transition temperature, and aggregation time. The resulting toner particles that can realize high quality images.

Macromonomers affect the polymerization reaction speed due to the large molecular structure thereof, and the molecular weight and the Tg of the latex can be adjusted by adjusting the addition amount of the macromonomers. The size of the toner particles can be adjusted by using latex having various molecular weights and with an adjusted Tg and by adjusting the amount of the aggregating agent during the aggregation process. Also, by varying the combination weight ratio of the different latex polymers or by changing the aggregation time, the shape of the toner particles can be adjusted to be spherical or potato-shaped as desired. The toner particles prepared in various shapes have good transferring and cleaning performance, and produce excellent toners with good durability and fixing properties.

The shape of the toner particles can be adjusted by the concentration and amount of the chain transfer agent. The lower the concentration of the chain transfer agent, the higher the molecular weight of the polymer latex and the lower the sphericity of the toner particles during the aggregation/melting. On the other hand, the higher the concentration of the chain transfer agent, the lower the molecular weight of the polymer latex and the more spherical (higher the sphericity) the toner particles become.

According to the current embodiment of the present invention, since a macromonomer used as a comonomer during the latex polymerization maintains the stability of the latex in an aqueous solution, it is not necessary to use an emulsifier. Ordinary emulsifiers are not used during the preparation process using emulsion polymerization, and thus a washing process during the separating and filtering process of the toner particles prepared after reaction can be reduced. As the washing process is reduced, the preparation process is simplified, and thus the manufacturing costs of the polymerization toner can be reduced, and the amount of the discharged wastewater is reduced, thus being environmentally friendly. Also, other problems such as low friction charge, toner storage instability, and image deterioration caused by the emulsifier can be reduced.

The macromonomers used in the current embodiment of the present invention are amphiphilic materials having both a hydrophilic group and a hydrophobic group, and are in the shape of a polymer or an oligomer having at least one reactive functional group at an end thereof.

The hydrophilic group of the macromonomers which is combined on the surface of the particles increases the long-term stability of the toner particles by steric stabilization, and can adjust the size of the latex particles according to the amount or molecular weight of the injected macromonomers. The hydrophobic group of the macromonomers exists on the surface of the toner particles and can facilitate emulsion polymerization reaction. Macromonomers can shape copolymers by being bonded with polymerizable monomers contained in the compositions by grafting, branching, or cross-linking.

The weight average molecular weight of the macromonomers according to the current embodiment of the present invention may be about 100 to 100,000, preferably 1,000 to 10,000. When the weight average molecular weight of the macromonomers is less than 100, the properties of the toner are not improved or the toner cannot function efficiently as a stabilizer. When the weight average molecular weight of the macromonomers is greater than 100,000, the reaction conversion rate may be lowered.

The macromonomers may be a material selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

When the amount of the macromonomers is less than 1 part by weight based on 100 parts by weight of the toner composition, the dispersion stability of the toner particles is reduced, and when the amount of the macromonomers is greater than 50 parts by weight, the properties of the toner are deteriorated.

The polymerizable monomer according to the current embodiment of the present invention can be selected from vinyl monomer, polar monomer having a carboxyl group, a monomer having an unsaturated polyester group, and a monomer having a fatty acid group.

The polymerizable monomer is at least one selected from the group consisting of styrene monomers such as styrene, vinyl toluene, α-methyl styrene; derivatives of (meth)acrylates such as methyl acrylate, ethyl acrylate, propyl acrylate, butyl acrylate, 2-ethylhexyl acrylate, dimethylamino ethyl acrylate methacrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylenically unsaturated monoolefins such as ethylene, butylenes, etc.; halogenized vinyls such as vinyl chloride, vinylidene chloride, vinyl fluoride, and like; vinyl esters such as vinyl acetate, vinyl propionate, and the like; vinyl ethers such as vinyl methyl ether, vinyl ethyl ether; vinyl ketones such as vinyl methyl ketone, methyl isopropenyl ketone, and the like; and nitrogen-containing vinyl compounds such as 2-vinylpyridine, 4-vinylpyridine, N-vinyl pyrrolidone, but is not limited thereto.

The amount of the polymerizable monomer may be about 3 to 50 parts by weight based on 100 parts by weight of the total amount of the toner composition. When the amount of the polymerizable monomer is less than 3 parts by weight based on 100 parts by weight of the total amount of the toner composition, the yield of the toner is reduced. When the amount of the polymerizable monomer is greater than 50 parts by weight, the stability of the toner is reduced.

The polymerizable monomer for forming the first through fourth latex polymer groups may be styrene, and may further include butyl acrylate and methacrylate. The amount of the styrene may be about 50 to 85 parts by weight based on 100 parts by weight of the used polymerizable monomer. When the amount of the styrene is less than 50 parts by weight, the Tg of the final toner is too low, and when the amount of the styrene is greater than 85 parts by weight, (1) aggregation does not occur properly. Amphiphilic macromonomers can function not only as a copolymer but also as a stabilizer. Initial reaction of radicals and monomers creates oligomer radicals and shows in situ stabilization effect. An initiator dissolved by heat creates radicals and reacts with a monomer in an aqueous solution and the hydrophobicity increases. Such hydrophobicity of oligomer radicals facilitates diffusion into micelle and reaction with polymerizable monomers, and together with this, a copolymerization reaction with macromonomers can be processed.

Due to the hydrophilicity of the amphiphilic macromonomers, copolymerization can easily occur in the vicinity of the surface of the toner particles. The hydrophilic portions of the macromonomers located on the surface of the toner particles increase the stability of the toner particles by steric stabilization, and the size of the toner particles can be adjusted according to the amount or molecular weight of the macromonomers. Also, functional groups reacting on the surface of the toner particles can improve the frictional electricity of the toner.

Examples of the chain transfer agent include sulfur containing compounds such as dodecanthiol, thioglycolic acid, thioacetic acid, and mercaptoethanol; phosphorous acid compounds such as phosphorous acid and sodium phosphate; hypophosphorous acid compounds such as hypophosphorous acid and sodium hypophosphate; and alcohols such as methyl alcohol, ethyl alcohol, isopropyl alcohol, and n-butyl alcohol, but are not limited thereto.

The toner composition may create radicals due to the initiator and the radicals may react with the polymerizable monomer. Radicals can react with reactive functional groups of the macromonomers and shape copolymers.

Examples of the radical initiator include persulfate salts such as potassium persulfate, ammonium persulfate, and the like; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) and the like; peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and the like. Also, an oxidization-reduction initiator in which the polymerization initiator and reduction agent are combined may be used.

According to an embodiment of the present invention, a colorant may be further included during the formation of the polymer latex or during the aggregating of the polymer latex. The colorant can be dispersed in a dispersion solution and mixed with a wax dispersion solution when preparing the polymer latex, and the colorant may be put in a dispersion solution during the aggregation process.

For black toner, carbon black or aniline black may be used as a colorant. The nonmagnetic toner according to the current embodiment of the present invention is efficient for preparing color toner. For color toner, carbon black is used for black color as a colorant, and yellow, magenta, and cyan colorants are further included for colored colorants.

For the yellow pigment, a condensation nitrogen compound, an isoindolinone compound, anthraquinone compound, an azo metal complex, or an allyl imide compound is used. For example, C.I. pigment yellow 12, 13, 14, 17, 62, 74, 83, 93, 94, 95, 109, 110, 111, 128, 129, 147, 168, 180, and the like can be used.

For the magenta pigment, a condensation nitrogen compound, an anthraquinone, quinacridone compound, base dye lake compound, naphthol compound, benzo imidazole compound, thioindigo compound, or perylene compound can be used. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254, and the like can be used.

For the cyan pigment, copper phthalocyanine compound and derivatives thereof, anthraquinone compound, or base dye lake compound can be used. For example, C.I. pigment blue 1, 7, 15, 15:1, 15:2, 15:3, 15:4, 60, 62, or 66, and the like can be used.

Such pigments can be used alone or in a combination of two pigments, and are selected in consideration of color, chromacity, luminance, resistance to weather, dispersion property in toner, etc.

The amount of the pigments as described above is preferably about 0.1 to 20 parts by weight, based on 100 parts by weight of the polymerizable monomer. The amount of the pigments is appropriate when the amount is enough to color the toner, however, when the amount of the pigment is less than 0.1 parts by weight based on 100 parts by weight of the polymerizable monomer, the coloring effect is not sufficient. When the amount of the pigments is greater than 20 parts by weight, the manufacturing costs of the toner increases, and thus sufficient frictional charge cannot be obtained.

The toner composition according to the current embodiment of the present invention may further include at least one selected from a release agent, a charge control agent, and wax.

The release agent can be used to protect a photoreceptor and prevent deterioration of developing, thereby obtaining a high quality image. A release agent according to an embodiment of the present invention may be a high purity solid fatty acid ester material. Examples of the release agent include low molecular weight polyolefins such as low molecular weight polyethylene, low molecular weight polypropylene, low molecular weight polybutylenes, and other; paraffin wax; multi-functional ester compound, and others The release agent used in the current embodiment of the present invention may be a multifunctional ester compound composed of alcohol having three functional groups or more and carboxylic acid.

The charge control agent may be selected from the group consisting of a salicylic acid compound containing metal such as zinc or aluminum, boron complex of bis diphenyl glycolic acid, and silicate. For example, dialkyl salicylic acid zinc, boro bis(1,1-diphenyl-1-oxo-acetyl potassium salt), and the like can be used.

The wax may be appropriately selected according to the purpose of the final toner. Examples of the wax that can be used include polyethylene-based wax, polypropylene-based wax, silicone wax, paraffin-based wax, ester-based wax, carnauba wax and, metallocene wax, but are not limited thereto. The melting point of the wax is preferably about 50° C. to about 150° C. Wax constituents is physically attached to the toner particles, but is preferably not covalently-bonded with toner particles. Thus, a toner that is fixed at a low fixing temperature on a final image receptor and shows excellent final image durability and resistance to abrasion is provided.

According to an embodiment of the present invention, polymer latex can be aggregated by heating to a temperature of its Tg or above. This is due to the increase of the Gibbs free energy of the latex polymer chain above the Tg temperature or above and the polymer latex particles can move freely, and thus toner particles having a smooth surface can be formed. The shape of the toner particles can be adjusted according to the temperature.

The morphological difference of the toner particles results from the interface force and the rheology of the toner particles. After a desired size and shape of the toner particles are obtained during the aggregation process, the toner particles are cooled below Tg and separated and dried through filtering. The dried toner particles are treated with external additives using silica, or other known additives, and the charge is adjusted to prepare final toner for laser printers. The time for aggregating polymer latex may be 3 to 12 hours. The volume average diameter of the toner particles prepared according to the current embodiment of the present invention may be about 0.5 to 20 μm, about preferably 5 to 10 μm.

According to another embodiment of the present invention, a toner is prepared by forming polymer latex particles by polymerizing a toner composition by mixing a macromonomer having hydrophilicity and hydrophobicity and including at least one reactive functional group, a polymerizable monomer, a chain transfer agent, and an initiator with the colorant dispersion solution to shape polymer latex particles and then by aggregating the polymer latex particles and separating and drying the aggregated toner, wherein the polymerizable monomer is selected to produce at least two polymer latex particles having different molecular weights, wherein the polymer latex particles are selected from the group consisting of a first polymer latex group having a weight average molecular weight of 20,000 or less, a second polymer latex group having a weight average molecular weight of 20,000 to 40,000, a third polymer latex group having a weight average molecular weight of 40,000 to 50,000, and a fourth polymer latex group having a weight average molecular weight of 50,000 to 100,000. Typically, the hydrophilic and hydrophobic properties of the polymer latex are provided by a hydrophilic group and hydrophobic group, respectively, on the macromonomer.

The radicals generated by the initiator react with the polymerizable monomer, and the radicals react with the polymerizable monomer and the macromonomer monomer reactive functional groups, and thus a copolymer can be formed. Copolymers can be formed by co-polymerizing at least one of a vinyl monomer, a polar monomer having a carboxyl group, a monomer having an unsaturated polyester group, and a monomer having a fatty acid group. The weight average molecular weight of the copolymer may be from 2,000 to 200,000.

The weight average molecular weight of the macromonomer may be about 100 to 100,000, preferably 1,000 to 10,000. Examples of the macromonomer include polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol (PEG)-hydroxyethylmethacrylate, hexa functional polyester acrylate, dendritic polyester acrylate, carboxy polyester acrylate, fatty acid modified acrylate, and polyester methacrylate, but are not limited thereto.

The volume average diameter of the prepared toner particles is about 0.5 to 20 μm, preferably about 5 to 10 μm.

The toner according to the current embodiment of the present invention may further include a release agent, wax, and a charge control agent, details of which are as described before.

According to another embodiment of the present invention, there is provided an image forming method including forming a visible image by disposing toner to a surface of a photoreceptor on which an electrostatic latent image is formed and transferring the visible image to the transferring medium, wherein the toner is prepared by forming polymer latex particles by polymerizing a toner composition by mixing a macromonomer having hydrophilicity, hydrophobicity, and at least one reactive functional group, a polymerizable monomer, a chain transfer agent, and an initiator with the colorant dispersion solution to shape polymer latex particles and then by aggregating the polymer latex particles and separating and drying the aggregated toner, wherein the polymerizable monomer is selected from at least two of the group consisting of a first group having a molecular weight of 20,000 or less, a second group having a molecular weight of 20,000 to 40,000, a third group having a molecular weight of 40,000 to 50,000, and a fourth group having a molecular weight of 50,000 to 100,000.

A representative electrophotographic image forming process includes charging, exposure to light, developing, transferring, fixing, cleaning, and an antistatic process operations, and a series of processes of forming images on a receptor.

In a conventional charging process, a photoreceptor is covered with electric charge of desired polarity, negative or positive charges, by a corona or a charge roller. In the light exposing process, an optical system, conventionally a laser scanner or an array of diodes selectively discharges the charged surface of the photoreceptor in an imagewise manner corresponding to a final visual image formed on a final image receptor to shape a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached onto the latent image by electrostatic electricity, and shape a tone image on the photoreceptor.

In the transferring process, the tone image is transferred to the final image receptor from a photoreceptor, and sometimes, an intermediate transferring element is used when transferring the tone image from the photoreceptor to affect the transfer of the tone image to the final image receptor.

In the fixing process, the tone image of the final image receptor is heated and the toner particles thereof are softened or melted, thereby fixing the tone image to the final image receptor. Another way of fixing is to fix toner on the final image receptor under high pressure with or without the application of heat. In the cleaning process, remaining toner on the photoreceptor is removed. Finally, in the antistatic process, charges of a photoreceptor medium/body are exposed to light of a predetermined wavelength band and are reduced to a substantially uniform, low value, and thus the residue of the original latent image is removed, and a photoreceptor is prepared for a next image forming cycle.

An image forming apparatus comprising: an organic photoreceptor; an image forming unit to form an electrostatic latent image on a surface of the organic photoreceptor; a toner cartridge to contain a toner; a toner supplying unit to supply the toner to the surface of the organic photoreceptor to develop the electrostatic latent image on the surface of the organic photoreceptor into a toner image; and a toner transferring unit to transfer the toner image n the surface of the organic photoreceptor to a transfer medium, wherein the toner is prepared by forming polymer latex particles by polymerizing a toner composition by mixing a macromonomer having hydrophilicity, hydrophobicity, and at least one reactive functional group, a polymerizable monomer, a chain transfer agent, and an initiator with the colorant dispersion solution to shape polymer latex particles and then by aggregating the polymer latex particles and separating and drying the aggregated toner, wherein the polymerizable monomer is selected to produce at least two groups of polymer latex particles having different molecular weights, wherein the polymer latex particles are selected from the group consisting of a first polymer latex group having a weight average molecular weight of about 20,000 or less, a second polymer latex group having a weight average molecular weight of about 20,000 to 40,000, a third polymer latex group having a weight average molecular weight of about 40,000 to 50,000, and a fourth polymer latex group having a weight average molecular weight of about 50,000 to 100,000.

FIG. 1 illustrates a non-contact developing type image forming apparatus accommodating a toner prepared according to an embodiment of the present invention. The operating principle of the non-contact developing type image forming apparatus is explained below.

A nonmagnetic one-component developer supplies a developer 8 onto a developing roller 5 by a feeding roller 6 formed of an elastic material such as polyurethane foam, sponge, etc. The developer 8 supplied onto the developing roller 5 reaches a contact portion between a developer regulation blade 7 and the developing roller 5 by rotation of the developing roller 5. The developer regulation blade 7 is constituted of an elastic member such as metal, rubber, etc. When the developer 8 passes the contact portion between the developer blade 7 and the developing roller 5, the developer 8 is formed into a thin layer having a predetermined thickness, and the developer 8 is sufficiently charged. The developer 8 that is made into a thin layer is transported by the developing roller 5 to the developing region where the developer 8 is developed on an electrostatic latent image of a photoreceptor 1 which is a latent image carrier.

The developing roller 5 is disposed in a position a predetermined distance away from the photoreceptor 1, facing the photoreceptor 1 without contacting the photoreceptor 1. The developing roller 5 rotates anti-clockwise and the photoreceptor 1 rotates clockwise. The developer 8 transported to the developing region is developed as an electrostatic latent image of the photoreceptor 1 by the electricity generated by the potential difference between voltage applied to the developing roller 5 and the potential of the latent image of the photoreceptor 1.

The developer 8 developed on the photoreceptor 1 reaches the position of a transferring device 9 according to the rotation direction of the photoreceptor 1. The developer 8 developed on the photoreceptor 1 is transferred to a paper 13 as the paper 13 passes through in a corona discharge or roller by a transferring device 9 to which a high voltage having inverse polarity with respect to the developer 8 is applied, thus forming an image.

The image transferred to the paper 13 passes through a high temperature and high pressure fixing unit (not shown) and the developer 8 is fused on the paper 13, thereby forming an image. The remaining developer 8 that is not developed on the developing roller 5 is returned by a supplying roller 6 that contacts the developing roller 5. The above process is repeated.

The present invention will be described in more detail with reference to the examples below, but is not limited thereto. The following examples are for illustrative purposes only and are not intended to limit the scope of the invention.

### EXAMPLE

Synthesis of latex A, B, C, and D

The inside of a reactor (1 L) was purged with nitrogen gas and 470 g of distilled deionized water and 5.0 weight % (with respect to monomer) poly(ethylene glycol)-ethyl ether methacrylate (PEG-EEM, Aldrich) mixture solution were added to the reactor and were agitated at 250 rpm and heated at the same time. When the inner temperature of the reactor reached 82° C., 2.0 g of potassium persulfate was dissolved in 50 g of deionized water and inputted into the reactor as a water-soluble free radical initiator, and 100 g of a monomer mixture of styrene, butyl acrylate, and methacrylic acid (containing 2 g of methacrylic acid, 65, 70, 75, or 80 g of styrene, and the amount of the butyl acrylate varies depending on the amount of the styrene) and 5% of 1-dodecanthiol, a chain transfer agent, were added to the reactor in a starved-feeding way. During the reaction, 15 g of ester wax was heated in 28.1 g of monomer mixture of styrene, butyl acrylate, and methacrylic acid (here, methacrylic acid is 0.56 g, and the amount of styrene is 22.4 g, 21 g, 19.6 g, or 18.2 g, and the amount of the butyl acrylate varies depending on the amount of the styrene) and 5% 1-dodecanthiol mixture solution and melted slowly, and dispersed in 190 g of distilled water and a macromonomer mixture solution to the same ratio of the initial reaction to prepare a wax dispersion solution. The prepared wax dispersion solution was put into the reactor, and 1 g of KPS was added to a deionized water reactor. The reaction time took 4-6 hours, and when the reaction was finished, the reactor was agitated and cooled naturally. The size of the toner latex particles after the reaction was 400 to 600 nm, and the conversion rate was near 100%. Polymer latex A, B, C, and D were obtained sequentially according to the ratio of styrene, and the kinds of the polymer latex are listed in Table 1 below:

TABLE 1

| | Amount | | | |
|---|---|---|---|---|
| | of Styrene | | | |
| | (among | Chain transfer | Molecular | |
| Latex | monomer) | agent | weight(Mw) | Tg (° C.) |
| A | 65 weight % | 5 weight % | 20,000 | 30–40 |
| B | 70 weight % | 5 weight % | 20,000–40,000 | 40–50 |
| C | 75 weight % | 5 weight % | 40,000–50,000 | 50–60 |
| D | 80 weight % | 5 weight % | 50,000–100,000 | 60–65 |

### Example 1

316 g of deionized water and 307 g of latex A and D synthesized using the above-described latex preparation process [(styrene)-(n-butyl acrylate)-(methacrylate)-(poly ethylene glycol-ethyl ether methacrylate) copolymer latex containing wax, latex A/D ratio=50/50] were added to a 1 L reactor and agitated at 350 rpm. During the agitation, 30 g of black pigment solution dispersed by a macromonomer was input. The pH of the overall solution was set as 11 and 30 g of MgCl₂ was input and heated stepwise up to 95° C. After two hours of reaction at 95° C., NaCl was input, and after four hours of reaction, the temperature of the mixture was cooled below the Tg of the polymer latex, and then through filtering, toner particles were separated and dried. The toner particles synthesized in this way were potato-shaped, and the particle size of the toner particles was about 6.5 μm in volume average.

### Example 2

A toner was prepared in the same manner as in Example 1 except that the latex A/D ratio was 80/20. The toner particles synthesized in this way were spherical type toner particles having a volume average diameter of about 6.7 μm.

### Example 3

A toner was prepared in the same manner as in Example 1 except that latex A/B was used instead of latex A/D, and the ratio thereof was 70/30. The toner particles synthesized in this way were spherical type toner particles having a volume average diameter of about 7.0 μm.

### Example 4

A toner was prepared in the same manner as in Example 1 except that latex A/B was used instead of latex A/D, and the ratio thereof was 20/80. The toner particles synthesized in this way were a potato type toner particles having a volume average diameter of about 6.8 μm.

### Example 5

A toner was prepared in the same manner as in Example 1 except that latex A/C was used instead of latex A/D, and the ratio thereof was 60/40. The toner particles synthesized in this way were potato type toner particles having a volume average diameter of about 6.9 μm.

### Example 6

A toner was prepared in the same manner as in Example 1 except that latex A/C was used instead of latex A/D, and the ratio thereof was 40/60. The toner particles synthesized in this way were potato type toner particles having a volume average diameter of about 6.7 μm.

### Example 7

A toner was prepared in the same manner as in Example 1 except that latex B/C was used instead of latex A/D, and the ratio thereof was 90/10. The toner particles synthesized in this way were potato type toner particles having a volume average diameter of about 6.6 μm.

### Example 8

A toner was prepared in the same manner as in Example 1 except that latex B/C was used instead of latex A/D, and the ratio thereof was 70/30. The toner particles synthesized in this way were potato type toner particles having a volume average diameter of about 6.5 μm.

### Example 9

A toner was prepared in the same manner as in Example 1 except that latex B/D was used instead of latex A/D, and the ratio thereof was 95/5. The toner particles synthesized in this way were potato type toner particles having a volume average diameter of about 6.6 μm.

### Example 10

A toner was prepared in the same manner as in Example 1 except that latex B/D was used instead of latex A/D, and the ratio thereof was 85/15. The toner particles synthesized in this way were irregular shaped toner particles having a volume average diameter of about 6.4 μm.

### Example 11

A toner was prepared in the same manner as in Example 1 except that latex C/D was used instead of latex A/D, and the ratio thereof was 80/20. The toner particles synthesized in this way were potato type toner particles having a volume average diameter of about 5.6 μm.

### Comparative Example 1

316 g of deionized water and 307 g of latex B [(styrene)-(n-butyl acrylate)-(methacrylate)-(poly ethylene glycol-ethyl ether methacrylate) copolymer latex containing wax] synthesized using the above-described latex preparation process were added to a 1 L reactor and agitated at 350 rpm. During the agitation, 30 g of black pigment solution dispersed by a macromonomer was input. The pH of the overall solution was set as 11 and 30 g of MgCl₂ was input and heated stepwise up to 95° C. After 2 hours of reaction at 95° C., NaCl was added, and after 4 hours of reaction, the temperature of the reaction result was cooled below Tg, and the toner particles were separated and dried through filtering. The toner particles synthesized in this way were potato type toner particles and the size of the toner particles was about 6.5 μm in volume average.

### Comparative Example 2

A toner was prepared in the same manner as in Comparative Example 1 except that the reaction took 8 hours. The toner particles synthesized in this way were spherical type toner particles having a volume average diameter of about 6.5 μm.

### Comparative Example 3

A toner was prepared in the same manner as in Comparative Example 1 except that latex A was used instead of latex B. The toner particles synthesized in this way were spherical type toner particles having a volume average diameter of about 7.0 μm.

### Comparative Example 4

A toner was prepared in the same manner as in Comparative Example 1 except that latex C was used instead of latex B. The toner particles synthesized in this way were potato type toner particles having a volume average diameter of about 6.7 μm.

### Comparative Example 5

A toner was prepared in the same manner as in Comparative Example 1 except that latex D was used instead of latex B. The toner particles synthesized in this way were irregular shaped toner particles having a volume average diameter of about 6.7 μm.

The results of Examples and Comparative Examples according to the combination ratio and the aggregation time are listed in Table 2 below:

TABLE 2

| | Comparative | Final Toner Shape | Final Toner Shape |
|---|---|---|---|
| Latex | Example | (4 h aggregation) | (8 h aggregation) |
| A:B | A > 40 | Spherical | Spherical |
| A:B | A < 40 | Potato | Spherical |
| A:C | A > 50 | Potato | Spherical |
| A:C | A > 50 | Potato | Potato |
| A:D | A < 70 | Spherical | Spherical |
| A:D | A > 70 | Potato | Potato |
| B:C | B > 80 | Potato | Spherical |
| B:C | B < 80 | Potato | Potato |
| B:D | B > 90 | Potato | Potato |
| B:D | B < 90 | Irregular | Irregular |
| C:D | — | Potato | Potato |
| A | 100 | Spherical | Spherical |
| B | 100 | Potato | Spherical |
| C | 100 | Potato | Potato |
| D | 100 | Irregular | Irregular |

As is evident from the above results, the size and shape of the final toner particles can be efficiently controlled by using at least two polymerizable monomers having different molecular weights and glass transition temperatures. Specifically, irregular particles and potato type toner particles are obtained from a polymerizable monomer having a high molecular weight, are obtained from a polymerizable monomer having a relatively high molecular weight, and spherical type toner particles are obtained from a polymerizable monomer having a relatively small molecular weight. Also, the potato type toner particles can be changed to spherical type toner particles by controlling the aggregation time of the polymerized polymer latex particles. Accordingly, the size and shape of the toner particles can be controlled by adjusting at least one condition selected from the molecular weight of the polymerizable monomer, glass transition temperature, and aggregation time, and thus toner particles for realizing high quality images can be obtained.

According to the present invention, the size and shape of the toner particles can be efficiently adjusted, and a toner having low temperature fixing properties, storability, cleaning properties and durability can be obtained. Also, the present invention provides a method of forming images and an image forming apparatus which can realize high quality images by employing toner with good properties.

While the present invention has been particularly shown and described with reference to exemplary embodiments thereof, it will be understood by those of ordinary skill in the art that various changes in shape and details may be made therein without departing from the spirit and scope of the present invention as defined by the following claims.

What is claimed is:

1. A method of preparing toner, the method comprising:
forming polymer latex particles by polymerizing a toner composition comprising a macromonomer having a hydrophilic group, a hydrophobic group, and at least one reactive functional group, a polymerizable monomer, a chain transfer agent, and an initiator;
aggregating the polymer latex particles; and
separating and drying the polymerized toner particles;
wherein the polymerizable monomer is selected to produce at least two groups of latex polymer particles having different molecular weights, wherein the polymer latex particles are selected from the group consisting of a first latex polymer group having a molecular weight (Mw) less than 20,000, a second latex polymer group having a molecular weight (Mw) of about 20,000 to 40,000, a third latex polymer group having a molecular weight (Mw) of about 40,000 to 50,000, and a fourth latex polymer group having a molecular weight (Mw) of about 50,000 to 100,000.

2. The method of claim 1, wherein the glass transition temperature of the first latex polymer group is about 30 to 40° C., the glass transition temperature of the second latex polymer group is about 40 to 50° C., the glass transition temperature of the third latex polymer group is about 50 to 60° C., and the glass transition temperature of the fourth latex polymer group is about 60 to 65° C.

3. The method of claim 1, wherein the polymerizable monomer is at least one selected from the group consisting of a vinyl monomer, a polar monomer having a carboxyl group, a monomer having an unsaturated polyester group, and a monomer having a fatty acid group.

4. The method of claim 1, wherein the polymerizable monomer is at least one selected from the group consisting of styrene, vinyl toluene, α-methyl styrene; methyl acrylate, ethyl acrylate, propyl acrylate, butyl acrylate, 2-ethylhexyl acrylate, dimethylamino ethyl acrylate methacrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylenically unsaturated monoolefins such as ethylene, butylenes, vinyl chloride, vinylidene chloride, vinyl fluoride, vinyl acetate, vinyl propionate, etc.; vinyl ethers such as vinyl methyl ether, vinyl ethyl ether; vinyl ketones such as vinyl methyl ketone, methyl isopropenyl ketone, 2-vinylpyridine, 4-vinylpyridine, and N-vinyl pyrrolidone.

5. The method of claim 1, wherein the polymerizable monomer is at least one selected from the group consisting of styrene monomers, derivatives of (meth)acrylates, halogenated vinyls, vinyl esters, and nitrogen containing vinyls compounds.

6. The method of claim 1, wherein the polymerizable monomer of the first through fourth latex polymer groups further comprises styrene, butyl acrylate, and methacrylate.

7. The method of claim 6, wherein the amount of the styrene is about 50 to 85 parts by weight based on 100 parts by weight of the polymerizable monomer.

8. The method of claim 1, wherein a colorant is further included during the forming of the polymer latex particles or the aggregating of the polymer latex particles.

9. The method of claim 1, wherein aggregating the polymer latex particles takes about 3 to 12 hours.

10. The method of claim 1, wherein the weight average molecular weight of the macromonomer is about 500 to 100,000.

11. The method of claim 1, wherein the macromonomer is at least one selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

12. The method of claim 1, wherein the amount of the macromonomer is about 1 to 50 parts by weight based on 100 parts by weight of the total amount of the toner composition.

13. The method of claim 8, wherein the colorant is one selected from the group consisting of yellow, magenta, cyan, and black pigments.

14. The method of claim 1, wherein the toner composition further comprises at least one selected from the group consisting of wax, a charge control agent, and a release agent.

15. A toner prepared from polymer latex particles prepared by polymerizing a toner composition by mixing a macromonomer having hydrophilicity and hydrophobicity, and at least one reactive functional group, a polymerizable monomer, a chain transfer agent, and an initiator with a colorant dispersion solution to produce polymer latex particles having a predetermined shape, and by aggregating the polymer latex particles and separating and drying the resulting aggregated toner,
wherein the polymerizable monomer is selected to produce at least two groups of polymer latex particles having different molecular weights, wherein the polymer latex particles are selected from the group consisting of a first latex polymer group having a molecular weight (Mw) of about 20,000 or less, a second latex polymer group having a molecular weight (Mw) of about 20,000 to 40,000, a third latex polymer group having a molecular weight (Mw) of about 40,000 to 50,000, and a fourth latex polymer group having a molecular weight (Mw) of about 50,000 to 100,000.

16. The toner of claim 15, wherein the glass transition temperature of the first polymer latex group is about 30 to 40° C., the glass transition temperature of the second latex polymer group is about 40 to 50° C., the glass transition temperature of the third latex polymer group is about 50 to 60° C., and the glass transition temperature of the fourth latex polymer group is about 60 to 65° C.

17. The toner of claim 15, wherein the polymerizable monomer of the first through fourth latex polymer groups further comprises styrene, butyl acrylate, and methacrylate.

18. The toner of claim 15, wherein the volume average diameter of the toner is about 0.5 to 20 μm.

19. The toner of claim 15, wherein the weight average molecular weight of the macromonomer is about 100 to 100,000.

20. The toner of claim 15, wherein the macromonomer is at least one selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

21. The toner of claim 15, further comprising at least one component selected from the group consisting of wax, a charge control agent, and a release agent.

22. An image forming method, comprising:
forming a visible image by disposing toner to a surface of a photoreceptor on which an electrostatic latent image is formed; and
transferring the visible image to a transfer medium,
wherein the toner is a toner of claim 15.

23. An image forming apparatus comprising:
an organic photoreceptor;
an image forming unit to form an electrostatic latent image on a surface of the organic photoreceptor;
a toner cartridge to contain the toner of claim 15;
a toner supplying unit to supply the toner to the surface of the organic photoreceptor to develop the electrostatic latent image on the surface of the organic photoreceptor into a toner image; and
a toner transferring unit to transfer the toner image on the surface of the organic photoreceptor to a transfer medium.
